(19) United States
(12) Patent Application Publication
(10) Pub. No.: US 2026/0161737 A1
(43) Pub. Date: Jun. 11, 2026

(54) CENTERED BINOMIAL DISTRIBUTION OPERATION

(71) Applicant: STMicroelectronics International N.V., Geneva (CH)

(72) Inventors: Jean-Francois DHEM, Halle (BE); Philippe BULENS, Nivelles (BE)

(73) Assignee: STMicroelectronics International N.V., Geneva (CH)

(21) Appl. No.: 19/413,912

(22) Filed: Dec. 9, 2025

(30) Foreign Application Priority Data
Dec. 11, 2024 (FR) FR2413831

(51) Int. Cl. G06F 17/18; H04L 9/06; H04L 9/30

(52) U.S. Cl. CPC G06F 17/18; H04L 9/06; H04L 9/3093

(57) ABSTRACT

This disclosure relates to a method for implementing a CBD operation taking as input two first data bits, and providing as output a list of second data bits. The method includes a step A for extracting a first half of bits from the first binary data, a step B for extracting a second half of bits from the first binary data, a step C for summing and masking the data from steps A and B to obtain fifth data and sixth data, a step D for extracting and masking the second data, and a step E for extracting and masking second data, with the order of implementation of steps A, B, C, D, and E being software-controlled.

### PRIORITY CLAIM

This application claims the priority benefit of French Application for Patent No. FR2413831, filed on Dec. 11, 2024, the content of which is hereby incorporated by reference in its entirety to the maximum extent allowable by law.

### TECHNICAL FIELD

The present disclosure generally relates to electronic systems and devices, and more particularly to the security of such electronic systems and devices and the information they handle. The present disclosure relates more specifically to the implementation of encryption or decryption algorithms, and to the implementation of centered binomial distribution operations of encryption or decryption algorithms.

### BACKGROUND

Various techniques are used today to secure secret and/or sensitive data. Data encryption is one of them, and involves the application of one or more cryptographic algorithms to data, such as sensitive data. Many cryptographic algorithms use matrices of data and/or polynomials.

The generation of these polynomials is often done during the implementation of these algorithms, and can use Centered Binomial Distribution (CBD) operations.

It would be desirable to be able to improve at least in part certain aspects of the implementation, by electronic systems and devices, of encryption or decryption algorithms, and more particularly the implementation of centered binomial distribution operations used by these algorithms.

There is a need for more secure and reliable implementations of cryptographic algorithms for encryption and/or decryption.

There is a need for more securely and reliably implementing the centered binomial distribution operations of these algorithms.

There is a need for implementations of centered binomial distribution operations that include masking steps.

There is a need to overcome some or all of the drawbacks of known implementations of encryption or decryption algorithms.

There is a need to overcome some or all of the drawbacks of known implementations of centered binomial distribution operations.

### SUMMARY

One embodiment provides a method for implementing a centered binomial distribution operation that takes as input at least two first binary inputs and outputs a list of second data bits, comprising the following steps: a step A for extracting third data corresponding to a first half of bits of the first binary input, this step A being implemented in hardware; a step B for extracting fourth data corresponding to a second half of bits, different from the first half, of the first binary input, this step B being implemented in hardware; a step C for summing and masking the third data to obtain fifth data, and the fourth data to obtain sixth data, this step C being implemented in hardware; a step D for extracting and masking the second data from the fifth data, this step D being implemented in hardware; and a step E for extracting and masking second data from the sixth data, this step E being implemented in hardware, wherein the order of implementation of steps A, B, C, D, and E is software-controlled.

Another embodiment provides a device comprising circuits suitable for implementing one or more steps in a method for implementing a centered binomial distribution operation that takes as input at least two first binary inputs and outputs a list of second data bits, comprising the following steps: a step A for extracting third data corresponding to a first half of bits of the first binary input, this step A being implemented in hardware; a step B for extracting fourth data corresponding to a second half of bits, different from the first half, of the first binary input, this step B being implemented in hardware; a step C for summing and masking the third data to obtain fifth data, and the fourth data to obtain sixth data, this step C being implemented in hardware; a step D for extracting and masking the second data from the fifth data, this step D being implemented in hardware; and a step E for extracting and masking second data from the sixth data, this step E being implemented in hardware, wherein the order of implementation of steps A, B, C, D, and E is software-controlled.

According to one embodiment, the first half of bits of the first binary input corresponds to a first group of bits comprising two bits out of four bits of the first binary input, and the second half of bits of the first binary input corresponds to a second group of bits comprising two further bits out of four bits of the first binary input.

According to one embodiment, in step C, the following mathematical equation is implemented to obtain said fifth data:

$${x}_{i}^{′} = ( x {1}_{2 i} xor x {2}_{2 i} ) + ( x {1}_{2 i + 1} xor x {2}_{2 i + 1} ) + {r}_{2 i} ,$$

Where: xor represents the logical operation EXCLUSIVE OR; + represents the arithmetic sum operation; x′i represents the bit of rank i in said fifth data; x1i represents the bit of rank i in said third data extracted from a first of said at least two first binary inputs; x2i represents the bit of rank i in said third data extracted from a second of said at least two first binary inputs; and ri represents the bit of rank i in a seventh masking data.

According to one embodiment, in step C, the following mathematical equation is implemented to obtain said sixth data:

$${y}_{i}^{′} = ( y {1}_{2 i} xor y {2}_{2 i}^{′} ) + ( y {1}_{2 i + 1} xor y {2}_{2 i + 1}^{′} ) + {r}_{2 i}$$

Where: xor represents the logical operation EXCLUSIVE OR; + represents the arithmetic sum operation; y′i represents the bit of rank i in said sixth data; y1i represents the bit of rank i in said fourth data extracted from said first of said at least two first binary inputs; and y2i represents the bit of rank i in said fourth data extracted from said second of said at least two first binary inputs.

According to one embodiment, step D comprises extracting at least two bits from said fifth data, and masking them using at least twelve bits of a second masking data.

According to one embodiment, step E comprises extracting at least two bits from said sixth data, and masking them using at least twelve bits of said second masking data.

According to one embodiment, said at least two first binary inputs each comprise at least one thousand twenty-four (1,024) bits.

According to one embodiment, said centered binomial distribution operation takes as input at least three first binary inputs.

According to one embodiment, steps A and B are performed in any order, and steps D and E are performed in any order.

Another embodiment provides a method for implementing a centered binomial distribution operation that takes as input a first binary input, and outputs a list of second data bits, comprising the implementation in hardware of a single step comprising implementing: a step A for in-place summing bits of the first binary input; a step B for subtracting data bits obtained in step A; and a step C for pairwise extracting the coefficients from the concatenation of data bits obtained in step B.

Another embodiment provides a device comprising circuitry suitable for implementing one or more steps in a method for implementing a centered binomial distribution operation that takes as input a first binary input, and outputs a list of second bits of data, comprising the implementation in hardware of a single step comprising implementing: a step A for in-place summing bits of the first binary input; a step B for subtracting data bits obtained in step A; and a step C for pairwise extracting the coefficients from the concatenation of data bits obtained in step B.

Another embodiment provides a method for implementing an encryption or decryption algorithm comprising the method described above.

Another embodiment provides a device for implementing an encryption or decryption algorithm comprising the device described above.

According to one embodiment, said encryption or decryption algorithm is the so-called module lattice-key encapsulation mechanism (ML-KEM) algorithm.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates an embodiment of an electronic device;

FIG. 2 illustrates an example embodiment of a method for generating an encryption and/or decryption key;

FIG. 3 illustrates an example embodiment of a method for encrypting an encryption and/or decryption key;

FIG. 4 illustrates a secure implementation of a centered binomial distribution operation;

FIG. 5 illustrates a further representation of the implementation illustrated in FIG. 4;

FIG. 6 illustrates the implementation of a step in the implementation shown in FIG. 4;

FIG. 7 illustrates the implementation of another step in the implementation shown in FIG. 4;

FIG. 8 illustrates the implementation of another step in the implementation shown in FIG. 4;

FIG. 9 illustrates the implementation of another step in the implementation shown in FIG. 4; and

FIG. 10 illustrates an implementation of a centered binomial distribution operation.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

In addition, in the following description, we refer to data, or data bits, as binary data, i.e. data expressed as one bit or a set of bits.

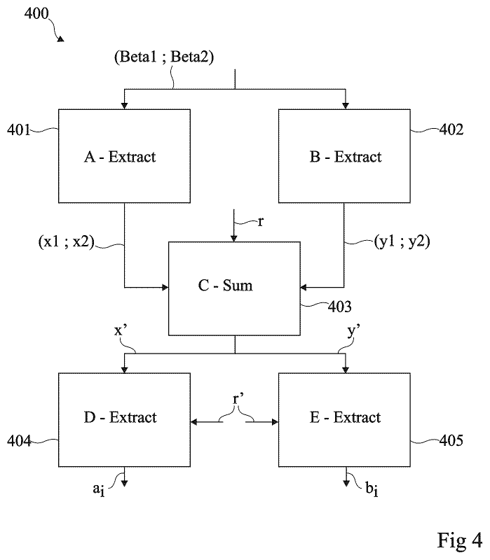

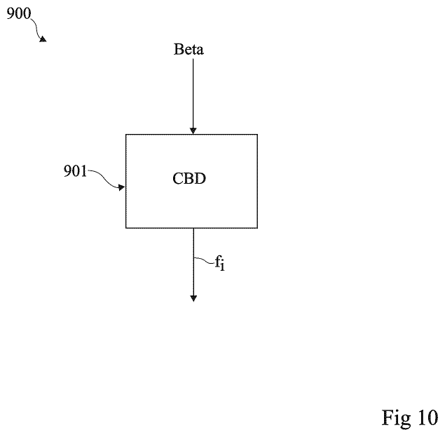

The embodiments described hereinafter relate to the implementation of a centered binomial distribution operation, and for example its use in an encryption or decryption algorithm. A Centered Binomial Distribution (CBD) operation is a mathematical operation allowing coefficients that can be used as polynomial coefficients, for example in a data encryption or decryption algorithm to be generated. The embodiments described hereinafter relate more precisely to a method for implementing such an operation, and to the device suitable for such an implementation. A first embodiment, described in relation to FIGS. 4 to 9, is a secure implementation of this operation, for which only five instructions are used, each implemented in software or hardware. A second embodiment, described in relation to FIG. 10, is a less secure implementation of this operation, for which only one instruction is used, and which is implemented in software or hardware.

In addition, the embodiments described herein are particularly suitable for use in any type of industrial market where the use of a centered binomial distribution operation is required. More particularly, an implementation of such an operation may be intended for: the automotive industry, for example in the field of automotive electrification or in the field of Advanced Driver Assistance Systems (ADAS); the industrial industry, for example in the field of green energy, infrastructure electrification, the Internet of Things (IoT) and smart home applications, where electricity and energy consumption and data exchange are key elements; the personal electronics industry, for example in the field of mobile telephony and the Internet of Things (IoT), in the field of broadband interfaces, as well as in the field of banking and electronic payments; and the communications equipment, computer, and peripherals industry, for example in the field of infrastructure and data centers, and in the field of Low Earth Orbit (LEO) satellites.

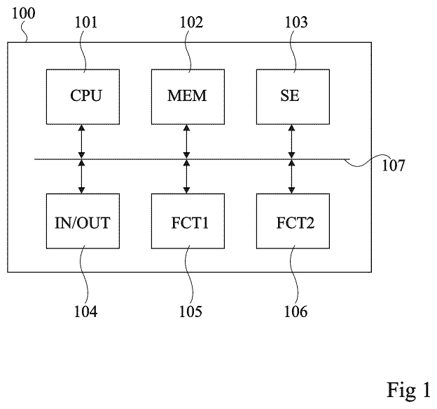

FIG. 1 is a block diagram illustrating, very briefly, an architecture of an example electronic device 100 suitable for implementing a centered binomial distribution operation, for example in the case of implementing an encryption or decryption algorithm.

According to one example, the electronic device 100 comprises a processor 101 (CPU) suitable for implementing various processing operations on data stored in memories and/or provided by other circuits of the device 100. According to one embodiment, the processor 101 is suitable for implementing a centered binomial distribution operation, and for example an encryption or decryption algorithm using such an operation.

According to one example, the electronic device 100 further comprises various types of memory 102 (MEM), including, for example, non-volatile memory, volatile memory, and/or read-only memory. Each memory 102 can be suitable for storing various types of data.

According to one example, the electronic device 100 further comprises, for example, a secure element 103 (SE) suitable for handling sensitive and/or secret data. The secure element 103 may comprise its own processor(s), memory(s), and so on. According to one embodiment, the secure element 103 is suitable for implementing a centered binomial distribution operation, and for example an encryption or decryption algorithm using such an operation.

According to one example, the electronic device 100 may further comprise interface circuits 104 (IN/OUT) suitable for sending and/or receiving data from outside the device 100. The interface circuits 104 may also be suitable for implementing a data display, for example, a display screen.

According to one example, the electronic device 100 further comprises various circuits 105 (FCT1) and 106 (FCT2) suitable for performing various functions. By way of example, circuits 105 and 106 could comprise measurement circuits, data conversion circuits, and similar circuits. According to one embodiment, circuits 105 and 106 could include a circuit suitable for implementing a centered binomial distribution operation, and for example an encryption or decryption algorithm using such an operation.

According to one example, the electronic device 100 further comprises one or more data buses 107 suitable for transferring data between its various components.

According to one particular example, the electronic device 100 is suitable for implementing computer programs, and in particular a computer program allowing all or part of the implementation of a centered binomial distribution operation, and for example an encryption or decryption algorithm using such an operation, to be implemented.

More precisely, the electronic device 100 is suitable for implementing at least one computer program product comprising program code instructions recorded on a medium usable in a computer, comprising computer-readable programming means for implementing a centered binomial distribution operation, and for example an encryption or decryption algorithm using such an operation.

In addition, the electronic device 100 comprises, among all the circuits described above, one or more circuits suitable for implementing one or more steps of implementing a centered binomial distribution operation.

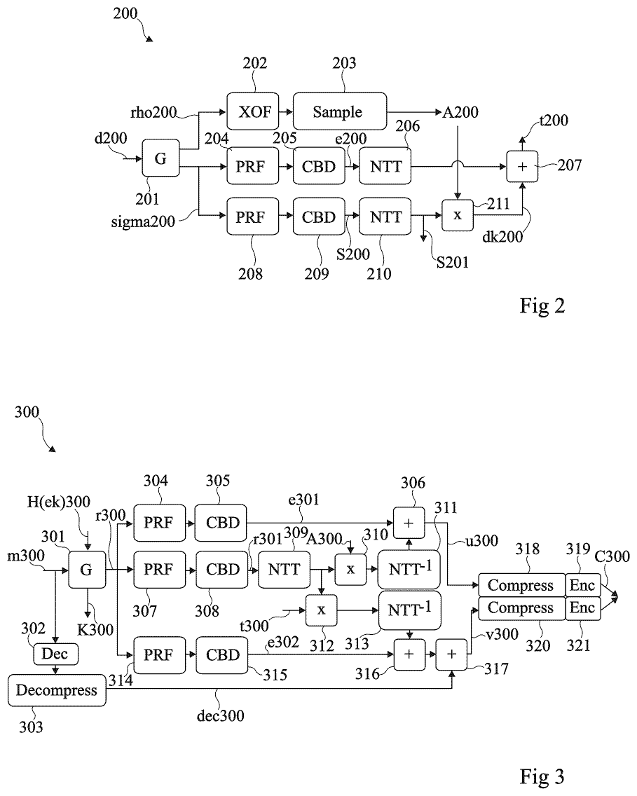

FIG. 2 is a block diagram illustrating the implementation of an algorithm 200 for generating a data encryption or decryption key using a centered binomial distribution (CBD) function.

According to one example, algorithm 200 is based on lattice-based cryptography. According to one preferred example, algorithm 200 is part of the data encapsulation mechanism called ML-KEM described above.

According to one example, the algorithm 200 is suitable for receiving, as input, data d200 enabling the generation, as output, of an encryption or decryption key t200.

According to one example, algorithm 200 comprises implementing a hash function 201 (G) suitable for receiving data d200 and for providing, as output, data rho200 and data sigma200.

According to one example, algorithm 200 comprises implementing functions 202 (XOF) and 203 (Sample). Function 202 is suitable for receiving data rho200, and for providing as output data to function 203. Function 203 provides as output data A200. According to one example, function 202 is a hash function the output size of which can be variable (XOF, extendable Output Function). According to one example, function 203 is a sampling function allowing a polynomial matrix to be provided from the result of function 202.

According to one example, algorithm 200 comprises implementing functions 204 (PRF) and 205 (CBD). Function 204 is suitable for receiving data sigma200, and for providing as output data to function 205. Function 205 provides as output data e200. According to one example, function 204 is a pseudo-random data generation function. According to one embodiment, function 205 is a centered binomial distribution function, which can be implemented using the embodiments described in relation to FIGS. 4 to 9.

According to one example, algorithm 200 comprises implementing functions 206 (NTT) and 207 (+). Function 206 is suitable for receiving data e200, and for providing as output data to function 207. Function 207 provides as output data t200 corresponding to part of the encryption or decryption key, which, when concatenated with data rho200, forms the encryption or decryption key. According to one example, function 206 is a number-theoretic transform (NTT) on a polynomial ring. According to one embodiment, function 207 is a polynomial sum function.

According to one example, algorithm 200 comprises implementing functions 208 (PRF) and 209 (CBD). Function 208 is suitable for receiving data sigma200, and for providing as output data to function 209. Function 209 provides as output data s200. According to one example, function 208 is identical to function 204. According to one embodiment, function 209 is a centered binomial distribution function like function 205.

According to one example, algorithm 200 comprises implementing functions 210 (NTT) and 211 (x). Function 210 is suitable for receiving data s200, and for providing as output data s201 to function 211. Data s201 is, for example, a secret part of the encryption and/or decryption key. Function 211 provides as output data dk200 to function 207. According to one example, function 210 is identical to function 206. According to one embodiment, function 211 is a polynomial multiplication function providing data dk200 to function 207.

FIG. 3 is a block diagram illustrating the implementation of an encryption 300 or encryption key encapsulation algorithm using a centered binomial distribution function.

According to one example, algorithm 300 is based on lattice-based cryptography. According to one preferred example, algorithm 300 is part of the data encapsulation mechanism called ML-KEM.

According to one example, the algorithm 300 is suitable for receiving as input: data t300 corresponding to data of the type t200 described in relation to FIG. 2; data A300 of the type of data A200 described in relation to FIG. 2; data m300 corresponding to a message to be encrypted; and data H (ek) 300 corresponding to hashed data obtained by hashing a public key, which could correspond to the concatenation of data t200 and rho200 described in relation to FIG. 2.

According to one example, algorithm 300 is suitable for providing, as output, data c300 corresponding to the key received as input ciphered, encrypted, or encapsulated, corresponding to the encryption or encapsulation of the data m300.

According to one example, algorithm 300 comprises implementing a hash function 301 (G) suitable for receiving data m300, and for providing, as output, data r300 and data K300.

According to one example, the algorithm 300 comprises implementing a decoding function 302 (Dec) and a function 303 (Decompress) which, applied successively to the data t300, allow data dec300 to be provided as output.

According to one example, algorithm 300 comprises implementing functions 304 (PRF) and 305 (CBD). Function 304 is suitable for receiving data r300, and for providing as output data to function 305. Function 305 provides as output data e301. According to one example, function 304 is identical to function 204 described in relation to FIG. 2. According to one embodiment, function 305 is a centered binomial distribution function like functions 205 and 209 described in relation to FIG. 2.

According to one example, algorithm 300 comprises implementing a function 306 (+) suitable for receiving, as input, data e301.

According to one example, algorithm 300 comprises implementing functions 307 (PRF) and 308 (CBD). Function 307 is suitable for receiving data r300, and for providing as output data to function 308. Function 308 provides as output data r301. According to one example, function 307 is identical to function 204 described in relation to FIG. 2. According to one embodiment, function 308 is a centered binomial distribution function like functions 205 and 209 described in relation to FIG. 2.

According to one example, algorithm 300 comprises implementing functions 309 (NTT), 310 (x) and 311 (NTT-1). Function 309 is suitable for receiving data r301, and for providing as output data to function 310. Function 310 provides as output data to function 311. Function 311 is suitable for providing data to function 306. Function 310 further receives data A300 as its input. According to one example, function 311 is the inverse function of function 309. According to one example, function 309 is identical to function 206 described in relation to FIG. 2. According to one example, function 310 is a polynomial multiplication function like function 211 described in relation to FIG. 2.

According to one example, algorithm 300 comprises implementing functions 312 (x) and 313 (NTT-1). Function 312 is suitable for receiving data t300 and data output from function 309, and for providing as output data to function 313. According to one example, function 312 is a polynomial multiplication function. According to one example, function 313 is the inverse function of function 309.

According to one example, algorithm 300 comprises implementing functions 314 (PRF) and 315 (CBD). Function 314 is suitable for receiving data r300, and for providing as output data to function 315. Function 315 provides as output data e302. According to one example, function 314 is identical to function 204 described in relation to FIG. 2. According to one embodiment, function 315 is a centered binomial distribution function like functions 205 and 209 described in relation to FIG. 2.

According to one example, algorithm 300 comprises implementing functions 316 (+) and 317 (+). Function 316 is suitable for receiving data e302 and providing as output data to function 317. Function 317 further receives data dec300 and provides as output data v300. According to one example, functions 316 and 317 are polynomial sum functions.

According to one example, the algorithm 300 comprises implementing a function 318 (Compress) and a function 319 (Enc) which, applied successively to the data u300 delivered by function 306, enable part of the data c300 to be provided as output.

According to one example, the algorithm 300 comprises implementing a function 320 (Compress) and a function 321 (Enc) which, applied successively to the data v300 delivered by function 317, enable the other part of the data c300 to be provided as output.

FIG. 4 is a block diagram illustrating a first embodiment of a method 400 for implementing a centered binomial distribution (CBD) operation.

Method 400 is suitable for implementation by a device of the type of device 100 described in relation to FIG. 1. More particularly, this device comprises hardware means, such as one or more discrete circuits and/or components, suitable for implementing at least one step of this method.

A centered binomial distribution operation, also known as a CBD operation, is a mathematical operation used to generate a list of data, for example a list of coefficients used to generate polynomials in an encryption algorithm, from input data. According to one example, to be implemented securely, this input data can be decomposed into at least two input shares, for example into two or three input shares. According to one example, there is no theoretical limitation on the number of shares into which the input data is decomposed; the limitations on this number are rather practical. Indeed, the greater the number, the longer the execution time of the CBD operation and the more complex its implementation (for example, the greater the hardware resources required for execution). The right compromise must therefore be found between the required level of security and the desired performance. In the example illustrated in FIG. 4, method 400 uses as input data decomposed into two shares Beta1 and Beta2. According to one example, this decomposition is a Boolean decomposition, and the application of the exclusive OR (XOR) function to data Beta1 and Beta2 makes it possible to recover the original input data. A decomposition into more shares is obvious to those skilled in the art based on this description.

Each coefficient fᵢ provided by the CBD operation is obtained by implementing the following mathematical operation:

$${f}_{i} = {\sum }_{i = 0}^{N} {a}_{i} - {b}_{i} ,$$

Where: N is an integer representing the number of CBD operation input coefficients, according to one example N is equal to 255; i is an integer between zero (0) and N; aᵢ is a first coefficient obtained from the CBD operation input data; and bᵢ is a second coefficient obtained from the CBD operation input data.

The first coefficient aᵢ is obtained by applying the following mathematical formula:

$${a}_{i} = {\sum }_{j = 0}^{n - 1} {Beta}_{2 in + j} ,$$

Where: j is an integer between zero (0) and n−1, n being equal to two (2) or three (3); Betaₖ represents the bit of rank k in one of the CBD operation inputs.

Similarly, the second coefficient bᵢ is obtained by applying the following mathematical formula:

$${b}_{i} = {\sum }_{j = 0}^{n - 1} {Beta}_{2 in + n + j} .$$

According to one embodiment, method 400 enables a centered binomial distribution operation to be implemented using software and hardware means. To this end, the implementation of this CBD operation is divided into five (5) distinct steps: steps 401 (A-Extract) and 402 (B-Extract) for extracting data; a step 403 (C-Sum) for data summing and masking; and steps 404 (D-Extract) and 405 (E-Extract) for extracting and masking data.

In step 401, data bits x1 and x2 are extracted from the input data Beta1 and Beta2. In the example described here, method 400 takes as input two data Beta1 and Beta2. According to one example, each bit packet is stored within a register. According to one practical example, data Beta1 and Beta2 are each binary words of one thousand twenty-four (1024) bits divided into sixteen (16) packets of sixty-four (64) bits.

According to one embodiment, data bits x1 are obtained by extracting bits from input data Beta1. More particularly, the data bits x1 are obtained by selecting a first half of the bits of the input data Beta1. According to one example, this first half of bits corresponds to all pairs of bits of index 4i+j, i and j being the integers defined above.

According to one embodiment, the data bits x2 are obtained by extracting bits from the input data Beta2. More particularly, the data bits x2 are obtained by selecting a first half of the bits of the input data Beta2. According to one example, this first half of bits corresponds to all bit pairs of index 4i+j.

In the case of the practical example described above, the data bits x1 and x2 are binary words of five hundred and twelve (512) bits divided into sixteen (16) packets of thirty-two (32) bits.

According to one embodiment, step 401 is implemented only in hardware and not in software. The repetition of step 401 can be implemented in software. As used herein, implementation in software refers to a step being implemented using a computer program or software program implemented by a complex electronic circuit, such as a processor, microprocessor, controller or microcontroller. Implementation in hardware refers to a step being implemented by using a component and/or an electronic circuit dedicated to the implementation of this step.

In the case of the practical example, step 401 can be implemented sequentially, processing only one bit packet of the input data Beta1 and Beta2 at a time. In this case, the implementation of step 401 comprises sixteen executions of the same operation.

In step 402, data bits y1 and y2 are extracted from the input data Beta1 and Beta2. Similar to step 401, according to one example, each bit packet is stored within a register.

According to one embodiment, the data bits y1 are obtained by extracting bits from the input data Beta1. More particularly, data bits y1 are obtained by selecting a second half of the bits of the input data Beta1, different from the first half of bits used in step 401. According to one example, this second half of bits corresponds to all pairs of bits of index 4i+2+j, i and j being the integers defined above.

According to one embodiment, the data bits y2 are obtained by extracting bits from the input data Beta2. More particularly, the data bits y2 are obtained by selecting a second half of the bits of the input data Beta2. According to one example, this second half of bits corresponds to all pairs of bits of index 4i+2+j, i and j being the integers defined above.

In the case of the practical example described above, the data bits y1 and y2 are binary words of five hundred and twelve (512) bits divided into sixteen (16) packets of thirty-two (32) bits.

According to one embodiment, step 402 is implemented only in hardware and not in software. The repetition of step 402 can be implemented in software.

In the case of the practical example, step 402 can be implemented sequentially, processing only one bit packet of the input data Beta1 and Beta2 at a time. In this case, the implementation of step 402 comprises sixteen executions of the same operation.

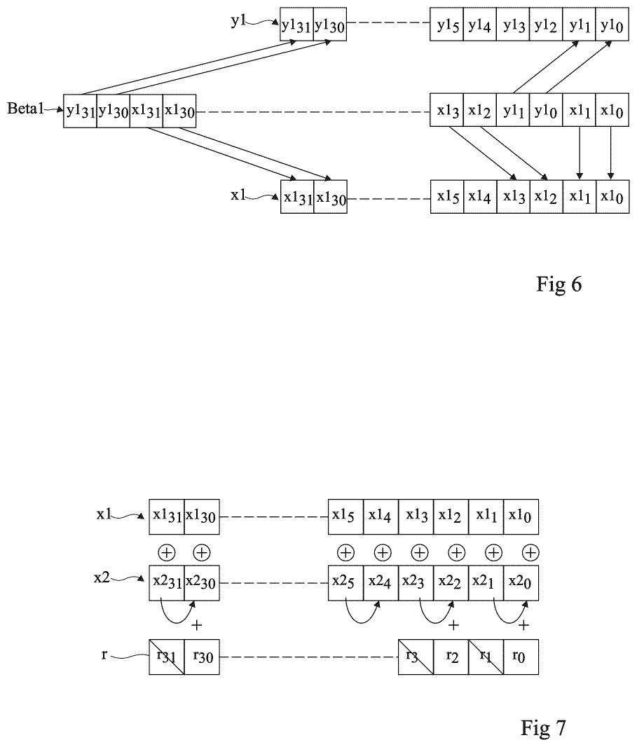

A practical illustration of implementing steps 401 and 402 is illustrated in FIG. 6.

In step 403, data bits x′ and y′ are obtained by summing and masking the bits of the data bits x1, x2 on the one hand, and by summing and masking the bits of the data bits y1, y2 on the other.

In particular, the data bits x′ are obtained by summing bits of the data bits x1 and x2. More precisely, each packet of bits of rank i in the data bits x′ is obtained by implementing the following mathematical formula:

$${x}_{i}^{′} = ( x {1}_{2 i} xor x {2}_{2 i} ) + ( x {1}_{2 i + 1} xor x {2}_{2 i + 1} ) + {r}_{2 i} ,$$

Where: xor represents the logical operation EXCLUSIVE OR; + represents the arithmetic sum operation; and rᵢ represents the bit of rank i in a masking data (rᵢ).

According to the practical example, each packet x′i of rank i in the data bits x′ comprises two bits, and step 403 is implemented sixteen (16) times to obtain the complete data bits x′.

Similarly, the data bits y′ are obtained by summing bits of the data bits y1 and y2. More precisely, each packet of bits of rank i in data bits y′ is obtained by implementing the following mathematical formula:

$${y}_{i}^{′} = ( y {1}_{2 i} xor y {2}_{2 i} ) + ( y {1}_{2 i + 1} xor y {2}_{2 i + 1} ) + {r}_{2 i} .$$

According to one embodiment, the masking data r is identical for data bits x′ and y′.

According to the practical example, each packet y′i of rank i in the data bits y′ comprises two bits, and step 403 is implemented sixteen (16) times to obtain the complete data bits y′.

According to one embodiment, step 403 can be performed separately to obtain the data bits x′ on one side and the data bits y′ on the other. The data bits x′ are stored in one register and the data bits y′ are stored in another register.

According to one embodiment, step 403 is implemented only in hardware and in a single operation.

A practical illustration of the implementation of step 403 is illustrated in FIG. 7.

In step 404, the coefficients aᵢ are extracted and masked from the data bits x′. To this end, each bit packet x′ᵢ of rank i is masked using bits of a masking data r′. According to the practical example, each bit packet x′ᵢ of two (2) bits is masked using, for example, a minimum of twelve (12) bits of masking r′ to obtain a packet of 16 masked bits. Step 404 is implemented one hundred and twenty-eight (128) times. The set of coefficients aᵢ is then stored within a register.

According to one embodiment, step 404 is implemented in hardware. The repetition of step 404 can be implemented in software.

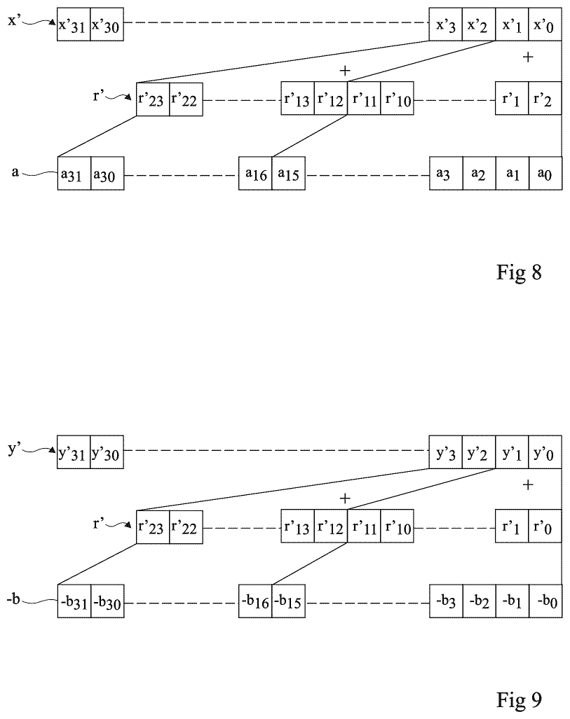

A practical illustration of the implementation of step 404 is illustrated in FIG. 8.

In step 405, the coefficients bᵢ are extracted and masked from the data bits y′. To this end, each bit packet y′ᵢ of rank i is masked using the bits of the masking data r′. According to the practical example, each bit packet y′ᵢ of two (2) bits is masked using, for example, a minimum of twelve (12) bits of masking r′ to obtain a packet of 16 masked bits. Step 405 is implemented one hundred and twenty-eight (128) times.

In addition, in step 405, the masked coefficients bᵢ are then inverted to obtain coefficients-bᵢ. The set of coefficients-bᵢ is then stored within a register.

According to one embodiment, the masking data r′ is identical for the data bits x′ and y′. According to one embodiment, the masking data r and r′ are preferably different to ensure better security of the CBD operation.

According to one embodiment, step 405 is implemented in hardware. The repetition of step 405 can be implemented in software.

A practical illustration of the implementation of step 405 is illustrated in FIG. 9.

According to one embodiment, steps 401 and 402 can be implemented independently of each other, and therefore in any order. In other words, step 401 can be implemented before, after or at the same time as step 402. According to one embodiment, step 403 can be applied to data bits x1, x2 and data bits y1, y2 independently and therefore in any order. In other words, step 403 can be applied to data bits x1, x2 before or after being applied to data bits y1 and y2. According to one embodiment, steps 404 and 405 can be implemented independently of each other, and therefore in any order. In other words, step 404 can be implemented before, after, or at the same time as step 405.

In other words, steps 401 to 405 can be implemented in any order, provided that these steps allow coefficients aᵢ and bᵢ to be obtained. Thus, according to one example, steps 401, 403 and 404 can in a first stage, be implemented to obtain the coefficients aᵢ, followed in a second stage, by steps 402, 403 and 405 to obtain the coefficients bᵢ. According to another example, steps 401 to 405 can be interleaved to obtain the coefficients aᵢ and bᵢ.

According to one embodiment, the order in which steps 401 to 405 are implemented may differ from one CBD operation to the next. According to one embodiment, the order in which steps 401 to 405 are implemented can be software-controlled.

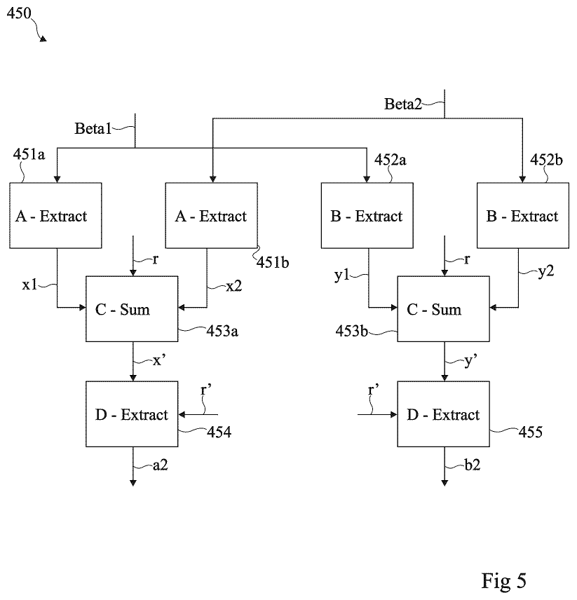

FIG. 5 illustrates, very schematically and in block form, the implementation of a method 450 for implementing a CBD operation of the same type as the method 400 described in relation to FIG. 4.

Method 450 is a further representation of method 400 described in relation to FIG. 4. More specifically, this method illustrates in detail the application of the various steps 401 to 405 described in relation to FIG. 4.

Method 450 comprises: a step 451a (A-Extract) of the type of step 401 described in relation to FIG. 4; a step 451b (A-Extract) of the type of step 401 described in relation to FIG. 4; a step 452a (B-Extract) of the type of step 402 described in relation to FIG. 4; a step 452b (B-Extract) of the type of step 402 described in relation to FIG. 4; a step 453a (C-Sum) of the type of step 403 described in relation to FIG. 4; a step 453b (C-Sum) of the type of step 403 described in relation to FIG. 4; and steps 454 (D-Extract) and 455 (E-Extract) for extracting and masking data.

Steps 451a and 451b represent the application of step 401 to each input data Beta1 and Beta2. More specifically, step 451a represents the application of step 401 to data Beta1 to obtain data x1, and step 451b represents the application of step 401 to data Beta2 to obtain data x2. Similarly, steps 452a and 452b represent the application of step 402 to each input data Beta1 and Beta2. In particular, step 452a represents the application of step 402 data Beta1 allowing data y1 to be obtained, and step 452b represents the application of step 402 to data Beta2 allowing data y2 to be obtained.

Steps 453a and 453b represent the application of step 403 to each data bit x1, x2 and y1, y2. More particularly, step 453a represents the application of step 403 to the data bits x1 and x2, and to the masking bits r, allowing data x′ to be obtained, and step 453b represents the application of step 403 to the data bits y1 and y2, and to the masking bits r, allowing data y′ to be obtained.

Step 454 represents the application of step 404 to the data bits x′ and the masking data r′.

Step 455 represents the application of step 405 to the data bits y′ and the masking data r′.

FIG. 6 shows, very schematically and according to the practical example, the implementation of steps 401 and 402 of the method 400 described in relation to FIG. 4.

In the example shown in FIG. 6, the data bits x1 and y1 are extracted from the input data Beta1. To this end, groups of two consecutive bits are formed from the input data Beta1.

One group of two bits out of four is extracted to form the data bits x1, and the other groups of two bits are used to form the data bits y1.

FIG. 7 illustrates, very schematically and according to the practical example, the implementation of step 403 of the method 400 described in relation to FIG. 4.

In the example shown in FIG. 7, the data bits x1 and x2 are summed and masked using masking data r, according to the formula described in relation to FIG. 4.

FIG. 8 illustrates, very schematically and according to the practical example, the implementation of step 404 of the method 400 described in relation to FIG. 4.

In the example shown in FIG. 8, the coefficients aᵢ are extracted from the data bits x′ and masked using the masking data r′.

FIG. 9 illustrates, very schematically, the implementation of step 405 of the method 400 described in relation to FIG. 4.

In the example shown in FIG. 9, the coefficients-bᵢ are extracted from the data bits y′, masked using the masking data r′ and then inverted.

More particularly, according to the practical example described above, the following mathematical operations can be implemented in steps 404 and 405:

$$\{ \begin{matrix}{a}_{2 i} = ( ( {x}^{′} ≫ s ) and 3 ) + ( {r}^{′} and OxFFFF ) \\ {a}_{2 i + 1} = ( ( {x}^{′} ≫ ( s + 2 ) ) and 3 ) + ( ( {r}^{′} ≫ 16 ) and OxFFFF )\end{matrix}$$

Where: >> represents the bit shift operation to the right; s represents an input value equal to a multiple of four; and represents the logical AND operation; and OxFFFF is a data the expression of which is given in hexadecimal, and

$$\{ \begin{matrix}{b}_{2 i} = - ( ( {y}^{′} ≫ s ) and 3 ) + ( {r}^{′} and OxFFFF ) \\ {b}_{2 i + 1} = - ( ( {y}^{′} ≫ ( s + 2 ) ) and 3 ) + ( ( {r}^{′} ≫ 16 ) and OxFFFF )\end{matrix}$$

Where: >> represents the bit shift operation to the right; s represents an input value equal to a multiple of four; and represents the logical AND operation; and OxFFFF is a data the expression of which is given in hexadecimal.

FIG. 10 is a block diagram illustrating a second embodiment of a method 900 for implementing a Centered Binomial Distribution (CBD) operation.

Method 900 is suitable for implementing the CBD operation described in relation to FIG. 4, but without performing any masking operations. It is therefore possible, in this case, to reduce method 900 to the implementation of a single step 901 (CBD) which comprises the execution of a single instruction. This instruction takes, as input, input data Beta, and provides, as output, the coefficients fᵢ as defined in relation to FIG. 4.

In particular, the calculations implemented by the CBD operation can all be implemented from the registers storing the input data Beta.

In the practical example described above, the data bits beta are binary words of one thousand twenty-four bits (1024) divided into thirty-two (32) packets of thirty-two (32) bits.

Thus, according to one embodiment, step 901 is implemented by a single step comprising the implementation of: a step A for in-place summing the bits Beta₂ᵢ and Beta₂ᵢ₊₁ of the input data Beta to obtain data bits corresponding to the interleaved bits aᵢ and bᵢ previously described; an step B for in-place subtracting to obtain data bits fᵢ; and a step C for pairwise extracting the coefficients of the concatenation of data bits f₂ᵢ₊₁ and f₂ᵢ.

According to one practical example, step C is executed four (4) times. In addition, still according to the practical example, to process all data bits of the input data Beta, step 901 is implemented thirty-two (32) times.

According to one embodiment, step 901 is implemented in software and/or hardware.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. A method for implementing a centered binomial distribution operation taking, as input, first data, and providing, as output, a list of second data bits, comprising the following steps:
(A) extracting third data corresponding to a first half of bits of the first data, wherein step (A) is implemented in hardware;
(B) extracting fourth data corresponding to a second half of bits, different from the first half, of the first data, wherein step (B) is implemented in hardware;
(C) summing and masking the third data to obtain fifth data, and the fourth data to obtain sixth data, wherein step (C) is implemented in hardware;
(D) extracting and masking second data bits from the fifth data, wherein step (D) is implemented in hardware; and
(E) extracting and masking second data bits from the sixth data, wherein step (E) is implemented in hardware;
wherein an order of implementation of steps (A), (B), (C), (D), and (E) is software-controlled.

2. The method according to claim 1, wherein:
the first half of bits of the first data corresponds to a first bit group comprising two bits out of four bits of the first data; and
the second half of bits of the first data corresponds to a second bit group comprising two further bits out of four bits of the first data.

3. The method according to claim 1, wherein, in step (C), a mathematical equation is implemented to obtain said fifth data as:
$${x}_{i}^{′} = ( x {1}_{2 i} xor x {2}_{2 i} ) + ( x {1}_{2 i + 1} xor x {2}_{2 i + 1} ) + {r}_{2 i} ,$$
where: xor represents a logical operation EXCLUSIVE OR; + represents the arithmetic sum operation; x′ᵢ represents a bit of rank i in said fifth data; x1ᵢ represents a bit of rank i in said third data extracted from a first of said first data; x2ᵢ represents a bit of rank i in said third data extracted from a second of said first data; and rᵢ represents a bit of rank i in a seventh masking data.

4. The method according to claim 1, wherein, in step (C), a mathematical equation is implemented to obtain said sixth data as:
$${y}_{i}^{′} = ( y {1}_{2 i} xor y {2}_{2 i}^{′} ) + ( y {1}_{2 i + 1} xor y {2}_{2 i + 1}^{′} ) + {r}_{2 i} ,$$
where: xor represents a logical operation EXCLUSIVE OR; + represents the arithmetic sum operation; y′ᵢ represents a bit of rank i in said sixth data; y1ᵢ represents a bit of rank i in said fourth data extracted from said first of said first data; and y2ᵢ represents a bit of rank i in said fourth data extracted from said second of said first data.

5. The method according to claim 1, wherein step (D) comprises extracting at least two bits from said fifth data, and masking them using at least twelve bits of a second masking data.

6. The method according to claim 5, wherein step (E) comprises extracting at least two bits from said sixth data, and masking them using at least twelve bits of said second masking data.

7. The method according to claim 1, wherein said first data each comprise at least one thousand twenty-four bits.

8. The method according to claim 1, wherein said centered binomial distribution operation takes as input at least three first data.

9. The method according to claim 1, wherein the order of implementation of steps (A) and (B) may be performed in any order, and the order of steps (D) and (E) may be performed in any order.

10. A method for implementing an encryption or decryption algorithm comprising the method according to claim 1, wherein said encryption or decryption algorithm is an ML-KEM algorithm.

11. A device comprising circuits suitable for implementing one or more steps of a method for implementing a centered binomial distribution operation taking, as input, first data, and providing, as output, a list of second data bits, and comprising steps for:
(A) extracting third data corresponding to a first half of bits of the first data, this step (A) being implemented in hardware;
(B) extracting fourth data corresponding to a second half of bits, different from the first half, of the first data, this step (B) being implemented in hardware;
(C) summing and masking the third data to obtain fifth data, and the fourth data to obtain sixth data, this step (C) being implemented in hardware;
(D) extracting and masking second data bits from the fifth data, this step (D) being implemented in hardware; and
(E) extracting and masking second data bits from the sixth data, this step € being implemented in hardware;
wherein an order of implementation of steps (A), (B), (C), (D), and (E) is software-controlled.

12. The device according to claim 11, wherein:
the first half of bits of the first data corresponds to a first bit group comprising two bits out of four bits of the first data; and
the second half of bits of the first data corresponds to a second bit group comprising two further bits out of four bits of the first data.

13. The device according to claim 11, wherein, in step (C), a mathematical equation is implemented to obtain said fifth data as:
$${x}_{i}^{′} = ( x {1}_{2 i} xor x {2}_{2 i} ) + ( x {1}_{2 i + 1} xor x {2}_{2 i + 1} ) + {r}_{2 i} ,$$
where: xor represents a logical operation EXCLUSIVE OR; + represents the arithmetic sum operation; x′ᵢ represents a bit of rank i in said fifth data; x1ᵢ represents a bit of rank i in said third data extracted from a first of said first data; x2ᵢ represents a bit of rank i in said third data extracted from a second of said first data; and rᵢ represents a bit of rank i in a seventh masking data.

14. The device according to claim 13, wherein, in step (C), a mathematical equation is implemented to obtain said sixth data as:
$${y}_{i}^{′} = ( y {1}_{2 i} xor y {2}_{2 i}^{′} ) + ( y {1}_{2 i + 1} xor y {2}_{2 i + 1}^{′} ) + {r}_{2 i} ,$$
where: xor represents a logical operation EXCLUSIVE OR; + represents the arithmetic sum operation; y′ᵢ represents a bit of rank i in said sixth data; y1ᵢ represents a bit of rank i in said fourth data extracted from said first of said first data; and y2ᵢ represents a bit of rank i in said fourth data extracted from said second of said first data.

15. The device according to claim 11, wherein step (D) comprises extracting at least two bits from said fifth data, and masking them using at least twelve bits of a second masking data.

16. The device according to claim 11, wherein step (E) comprises extracting at least two bits from said sixth data, and masking them using at least twelve bits of said second masking data.

17. The device according to claim 11, wherein said first data each comprise at least one thousand twenty-four bits.

18. The device according to claim 11, wherein said centered binomial distribution operation takes as input at least three first data.

19. The device according to claim 11, wherein the order of implementation of steps (A) and (B) may be performed in any order, and the order of steps (D) and (E) may be performed in any order.

20. A device for implementing an encryption or decryption algorithm comprising the device according to claim 11, wherein said encryption or decryption algorithm is an ML-KEM algorithm.

21. A method for implementing a centered binomial distribution operation taking as input a first data, and providing as output a list of second data bits, comprising implementation in hardware of a single step comprising implementation of steps of:
(A) in-place summing of bits of the first data;
(B) subtracting data bits obtained in step (A); and
(C) pairwise extracting coefficients of concatenation of data bits obtained in step (B).
